(19) United States
(12) Patent Application Publication
(10) Pub. No.: US 2006/0249544 A1
(43) Pub. Date: Nov. 9, 2006

(54) Multiple pour pitcher

(75) Inventor: Gunter Woog, West Bend, WI (US)

Correspondence Address: WEISS & WEISS, Suite 251, 300 Old Country Road, Mineola, NY, 11501, US

(73) Assignee: USI INTERNATIONAL

(21) Appl. No.: 11/122,869

(22) Filed: May 5, 2005

(51) Int. Cl. A47J 45/06

(52) U.S. Cl. 222/466; 222/143

(57) ABSTRACT

A multiple pour pitcher comprising multiple spouts.

### FIELD OF THE INVENTION

The present invention relates to a multiple pour pitcher having multiple spouts.

### BACKGROUND OF THE INVENTION

Pitchers in the prior art have one handle and one spout. When a person needs to pour a pitcher after a person on the opposite side of the table has poured from the pitcher, the second person must reach over and grab the handle and turn the pitcher in order to pour from the pitcher.

Further, when a waiter is filling glasses from a standard one spout, one handle pitcher, the waiter must continually position himself in front of the glass in order to fill it.

### SUMMARY OF THE INVENTION

The present invention relates to a multiple pour pitcher comprising a pitcher having multiple spouts. It is an object of the present invention for the pitcher to have at least one handle. It is an object of the present invention for the pitcher to have two spouts. It is an object of the present invention for the pitcher to have three spouts. It is an object of the present invention for the pitcher to have four spouts. It is an object of the present invention for the pitcher to have at least three spouts. It is an object of the present invention for the spouts to be equally spaced from each other.

It is an object of the present invention for the pitchers having equal number of spouts to be stacked with other similar pitchers.

It is an object of the present invention for the pitcher to have at least two handles, and at least two spouts.

It is an object of the present invention for the pitcher to have two handles. It is an object of the present invention for the pitcher to have three handles. It is an object of the present invention for the pitcher to have four handles. It is an object of the present invention for the number of handles to match the number of spouts. It is an object of the present invention for the handles to be equally spaced from each other.

It is an object of the present invention for the handles to be removable, so that any number of handles can be used by the user at a given time. It is an object of the present invention for the handles to fit over the spouts.

It is an object of the present invention for a top to be placed on the pitcher, and for the top to have openings to allow a liquid to be poured through a spout when the openings line up with a spout.

It is an object of the present invention for the pitcher to have an insert which can be placed inside of the pitcher. The insert divides the pitcher into sections depending on how many spouts are in the pitcher. Each section has one spout. A pitcher that has three spouts is divided into three evenly divided sections. It is an object of the present invention for the pitcher to contain different drinks in each section of the pitcher, and for a person to be able to pour the pitcher and only pour one liquid without mixing it with the other liquids. It is an object of the present invention for a top to be inserted in the pitcher over the insert.

### BRIEF DESCRIPTION OF THE DRAWINGS

FIG. 1 is a side view of the device of the present invention;

FIG. 2 is a broken view of the device of the present invention;

FIG. 3 is a side view of the device of the present invention;

FIG. 4 is a view showing the two devices in an unstacked position;

FIG. 5 shows two devices of FIG. 4 in a stacked position;

FIG. 6 is a side view of the devices in a stacked position;

FIG. 7 is a side view of the devices in a stacked position;

FIG. 8 is a view of the device showing the pitcher and insert separated;

FIG. 9 is a top view of the device having an insert; and

FIG. 10 is a side view of the device having an insert and showing a top to be placed on the device.

### DETAILED DESCRIPTION OF THE INVENTION

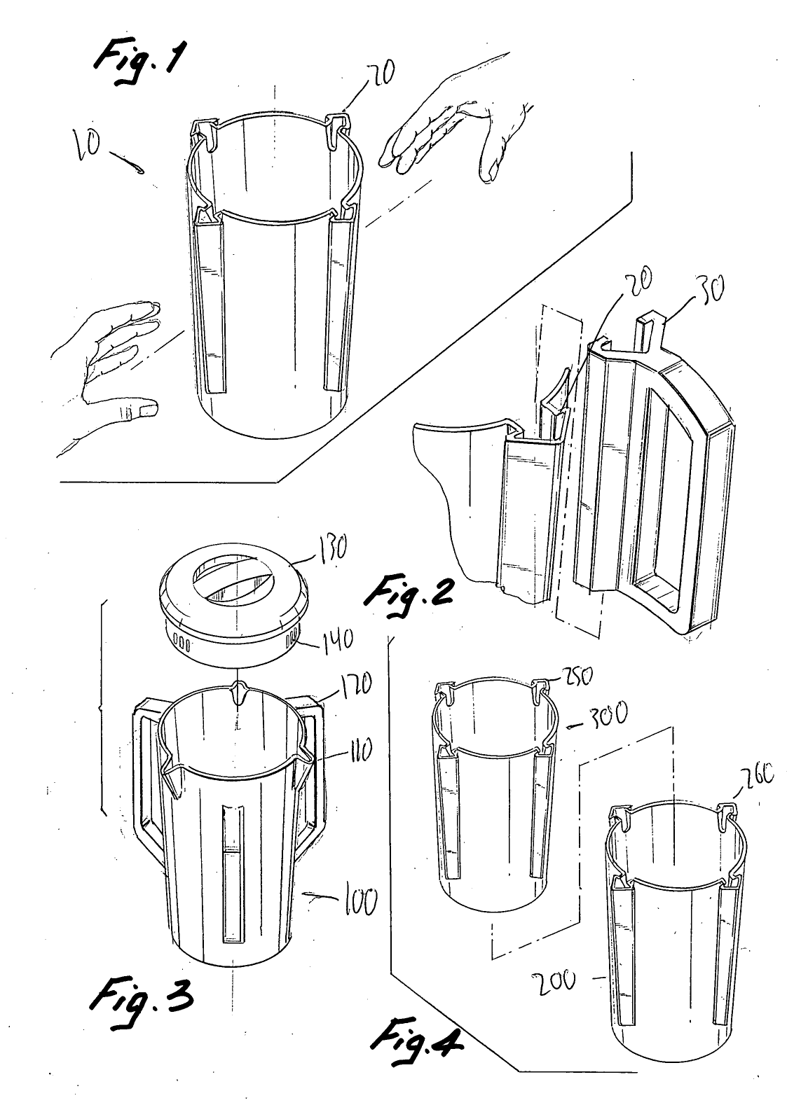

FIG. 1 shows a pitcher 10 having four spouts 20.

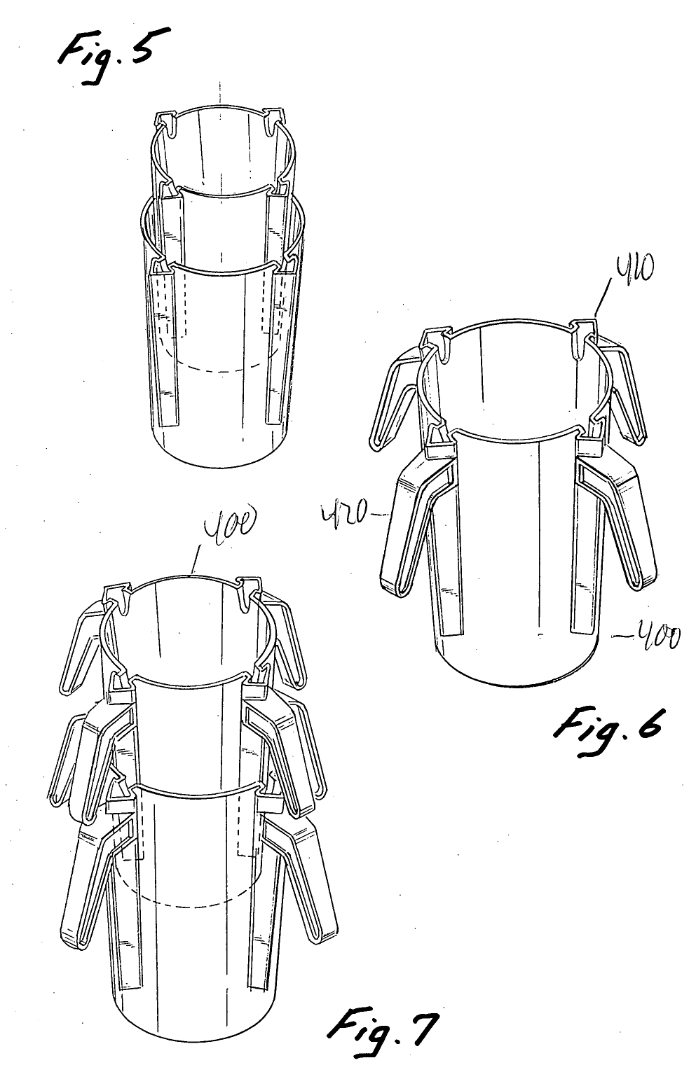

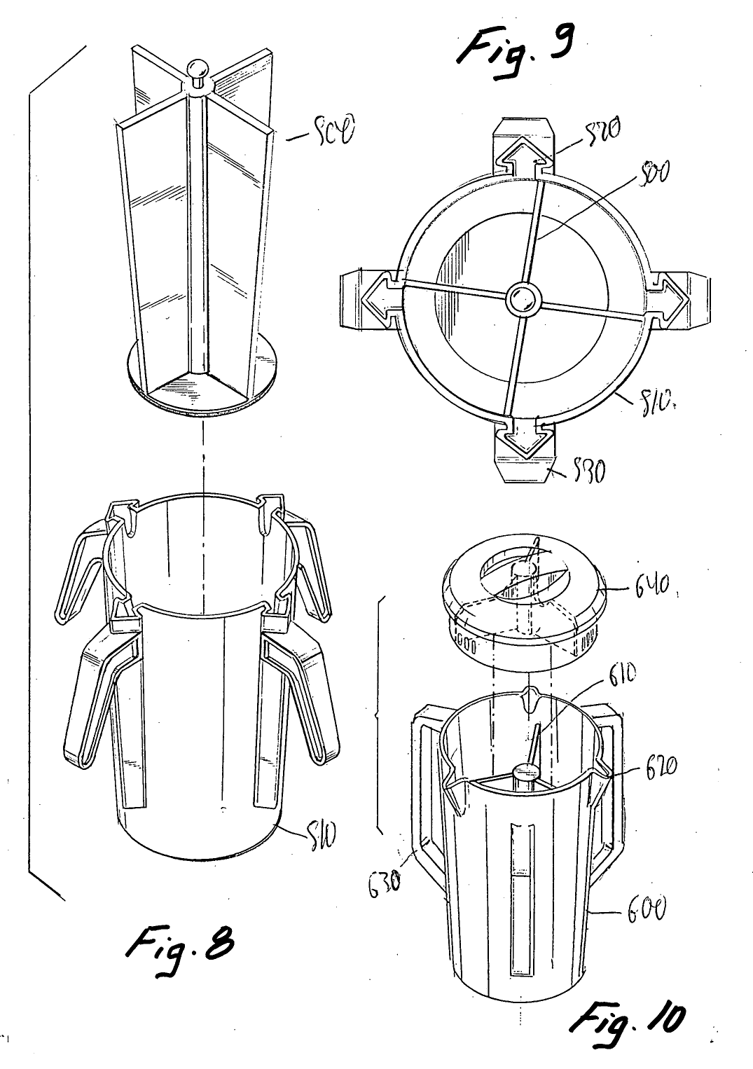

FIG. 2 shows spout 20 having a handle 30 placed on it.

FIG. 3 shows a pitcher 100 having spouts 110, handles 120, and a top 130. The top 130 has holes 140 which allow the liquid in the pitcher 100 to flow through it.

FIG. 4 shows pitchers 200 and 300 each having an equal number of spouts 260 and 250 respectively.

FIG. 5 shows pitcher 300 being stacked inside pitcher 200, with the spouts 250 fitting inside spouts 260.

FIG. 6 shows a single pitcher 400 having spouts 410 and handles 420.

FIG. 7 shows the pitcher 410 of FIG. 6 being stacked inside similar pitchers 400.

FIG. 8 shows an insert 500 which is placed inside a pitcher 510.

FIG. 9 shows the insert 500 inside the pitcher 510. The pitcher 510 is divided into four equal quadrants. Each quadrant has a spout 520 and a handle 530.

FIG. 510 shows a pitcher 600 having an insert 610, spouts 620, handles 630 and a top 640.

It will be apparent to those skilled in the art that various modifications of the foregoing illustrative embodiment are possible. Thus, the invention also encompasses any and all embodiments within the scope of the following claims.

1. A multiple pour pitcher comprising
a pitcher; and
at least three spouts.

2. The multiple pour pitcher of claim 1 wherein said pitcher comprises four spouts.

3. The pitcher of claim 1 wherein said pitcher has at least one handle.

4. The pitcher of claim 1 wherein said spouts are equally spaced from each other.

5. The pitcher of claim 4 wherein pitchers having equal number of spouts can be stacked with other similar pitchers.

6. A multiple pout pitcher comprising:
a pitcher;
at least two spouts;
at least two handles.

7. The pitcher of claim 6 wherein said spouts and said handles are equally spaced from each other.

8. The pitcher of claim 6 wherein said number of handles is same as number of spouts.

9. The pitcher of claim 6 wherein said handles are removable.

10. The pitcher of claim 6 wherein said handles fit over said spouts.

11. The pitcher of claim 6 further comprising a top.

12. The pitcher of claim 11 wherein said top comprises openings to allow a liquid to be poured through said spout when said openings line up with said spout.

13. The pitcher of claim 6 further comprising:
an insert which is placed inside of said pitcher.

14. The pitcher of claim 13 wherein said insert divides said pitcher into sections equal to number of spouts on said pitcher.

15. The pitcher of claim 14 wherein said sections each contain a different drink in each section of said pitcher.

16. The pitcher of claim 15 wherein said pitcher pours only one drink at a time without mixing with other drinks in said pitcher.

17. The pitcher of claim 13 wherein said pitcher further comprises a top to be inserted in said pitcher over said insert.

18. The pitcher of claim 6 wherein said pitchers having equal number of spouts can be stacked with other similar pitchers.
